(19) United States
(12) Patent Application Publication
(10) Pub. No.: US 2008/0190394 A1
(43) Pub. Date: Aug. 14, 2008

(54) CYLINDER HEAD WITH MULTIPLE OIL PASSAGES AND METHOD FOR MANUFACTURE

(76) Inventors: Thomas C. Edelmayer, Canton, MI (US); Thomas E. Rome, Burlington, MI (US)

Correspondence Address: ARTHUR J. PLANTAMURA, ESQ.;GENERAL CHEMICAL PERFORMANCE PRODUCTS LLC., 90 EAST HALSEY ROAD, PARSIPPANY, NJ, 07054, US

(21) Appl. No.: 12/019,783

(22) Filed: Jan. 25, 2008

Related U.S. Application Data
(60) Provisional application No. 60/889,617, filed on Feb. 13, 2007.

(51) Int. Cl. F02F 1/42

(52) U.S. Cl. 123/193.5; 184/6.8

(57) ABSTRACT

A novel device and method is provided for incorporating oil passageways in existing cylinder head assemblies of an overhead cam type engine valve train. The system provided utilizes a longitudinal preformed metal tube which contains multiple separate longitudinal passageways. In the course of the assembly of the tube in the cylinder head, a temperature differential is employed, e.g., the tube is cooled such as by cryogenic means to reduce its outer diameter and/or the cylinder head is heated and the tube is inserted into a mating opening in the cylinder head to provide a permanent interference fit.

### CROSS-REFERENCE TO RELATED APPLICATION

This application claims the benefit of Provisional Application Ser. No. 60/889,617, filed on Feb. 13, 2007.

### FIELD OF THE INVENTION

The present invention describes an engine cylinder head incorporating an overhead cam type of engine valve train described as “end pivot rocker arm with hydraulic lash adjuster.” More particularly, the invention relates to the provision of a cylinder head containing multiple lubricating oil passageways and to the method for the introduction of said passageways.

### BACKGROUND OF THE INVENTION

In cylinder heads incorporating an overhead cam type of engine valve train described as “end pivot rocker arm with hydraulic lash adjuster”, the oil passageway provided is typically a longitudinally deep hole drilled to intersect with the sides of nearly perpendicularly blind drilled holes into which are installed the hydraulic lash adjusters. This oil passageway provides pressurized oil necessary to permit the hydraulic lash adjusters to perform the valve lash adjustment function effectively.

The deep hole drilling process used to produce longitudinal oil passages in engine cylinder heads as shown for example in U.S. Pat. No. 6,235,634, requires a relatively large diameter drill bit, the diameter of which cannot practically be made sufficiently small so as to provide two parallel oil passageways which is desired and is usually necessary for suitable performance of the valve deactivating mechanism. A drill bit of the small size to provide oil passageways of the desired diameter is not only difficult to direct accurately, but also as a practical matter, lacks the strength necessary to form the passageways. Such cylinder heads typically require at least two separate oil supplies, one for nearly constant pressure lubricating oil and one for modulated low and high pressure oil as is necessary to deploy a hydraulically actuated mechanism such as a valve deactivating device. The reduction of the diameter of oil passageways is also desirable so as to reduce the volume of oil and thereby reduce the time at engine startup to fill oil passages with oil and to reduce the transmission time of pressure modulated hydraulic signals.

Because the deep hole drilling process precludes the forming of oil passageways of a sufficiently small diameter, as well as not permitting the forming of a parallel, secondary and correctly directed oil passageway to supply a desired modulated low and high pressure oil necessary to perform the desired function, the valve deactivating hydraulic lash adjusters cannot function efficiently. Accordingly, means that afford the provision a plurality of, i.e. of a secondary oil passageway suitable for existing cylinder heads without requiring significant costly changes involved in casting and machining or additional equipment that might interfere with the placement of other components, i.e. fuel injectors, spark plugs, valve springs, intake and exhaust ports, etc., within the cylinder head would be highly desirable.

### SUMMARY OF THE INVENTION

In accordance with the invention, means are provided that permit the provision of a plurality, preferably two separate and different lubricating oil passageways for valve deactivating hydraulic lash adjusters; one for switching and one for lash adjustment. The deep hole drilling process used to produce longitudinal oil passages in engine cylinder heads requires that a sufficiently large diameter tool be used to avoid bending and distortion of the drill bit. As a consequence the diameter cannot be made of a sufficiently small diameter so as to permit the provision of two parallel oil passageways which are desired and necessary for a suitable performing valve deactivating mechanism. Suitable performing deactivation mechanisms typically require two separate oil supplies. At least a second passageway being necessary to provide nearly constant pressure lubricating oil and to modulate low and high pressure oil as is necessary to deploy a hydraulically actuated mechanism such as a valve deactivating device. The reduction in the diameter of oil passageways also functions to reduce oil volume and thereby reduces the engine startup time needed to fill oil passages with oil and to reduce the transmission time of pressure modulated hydraulic signals.

While prior art arrangements may include a construction that includes a second, large diameter oil passageway, such arrangements are generally not acceptable, i.e. not practical, for existing cylinder heads because of the significant, costly changes that are required to casting and machining equipment needed for assimilation in current systems. Additionally such relatively large drillings would generally not be acceptable for new cylinder head designs because it would interfere with the placement of other components, i.e. fuel injectors, spark plugs, valve springs, etc., and features such as intake and exhaust ports, etc. associated with the cylinder head.

In a preferred embodiment, the invention comprises an extruded tube of a suitable material e.g. aluminum, incorporating at least two preformed, generally coextensive, separate, distinct and substantially parallel longitudinal passageways. In assembling the tube with the preformed passageways, a temperature differential is preferably created between the tube and the cylinder head which facilitates insertion of the tube in the mating opening in the cylinder head. For example, the tube with the preformed passageways may be cooled e.g., using cryogenic means to reduce the outer diameter and then inserting the tube into the opening in the cylinder head. Upon equalization of the temperature, the tube is permanently interference fitted into the cylinder head. Alternatively, the cylinder head may be heated to facilitate insertion of the tube to accomplish essentially the same result. Additionally, the tube may be cooled and the cylinder head heated at the time of the insertion of the tube into the cylinder head.

### BRIEF DESCRIPTION OF THE FIGURES

FIG. 1 illustrates an extruded tube of the kind contemplated by the invention.

FIG. 1A is a cross section view of the tube of FIG. 1 illustrating the two separate interior oil passageways.

FIG. 2 illustrates a prior art cylinder head as taken from U.S. Pat. No. 6,325,034 (the disclosure of which is incorporated herein by reference). The dual oil passageway arrangement of the invention replaces the single drilled hole oil passageway arrangement shown in U.S. Pat. No. 6,325,034.

FIG. 3 illustrates a cylinder head of the kind shown in FIG. 2 that has been modified to incorporate the improved modification of the invention.

### DETAILED DESCRIPTION OF THE INVENTION

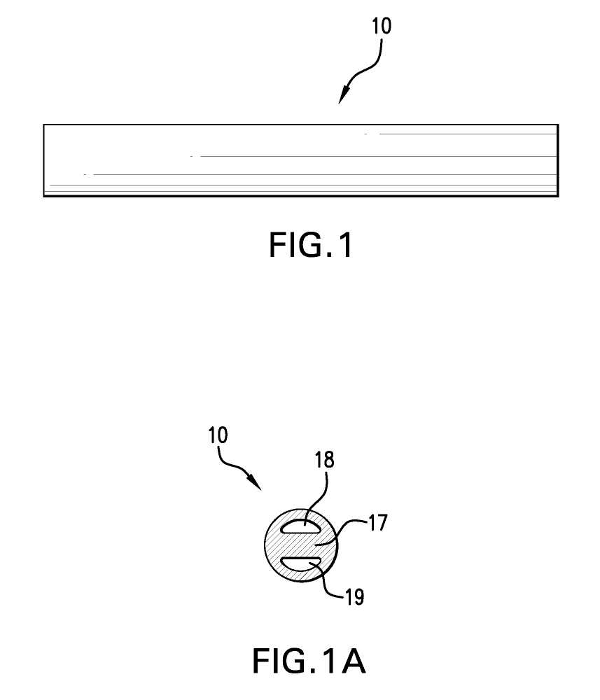

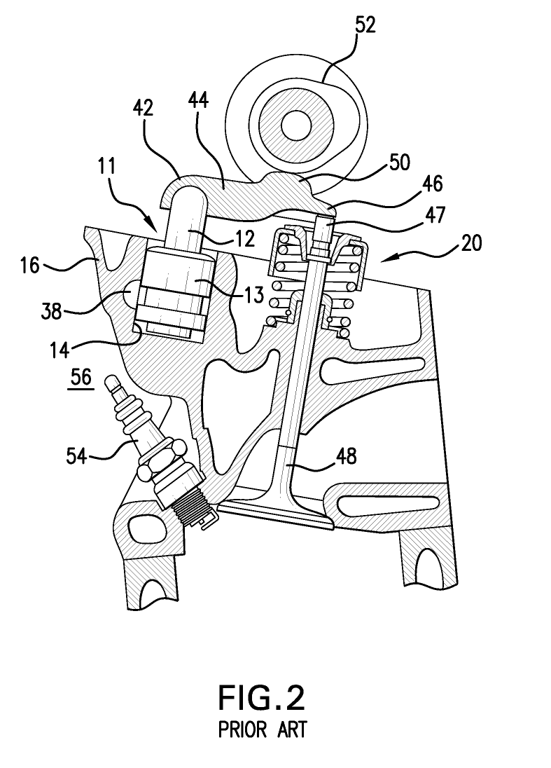

Referring to the drawing, FIG. 1 illustrates an extruded tube 10 preferably a metal e.g. aluminum as shown in FIG. 1A which includes two separate, parallel passageways 18 and 19 separated by a bulkhead 17 of a suitable thickness i.e. of at least 1 mm in width of the kind contemplated by the invention. In the preferred embodiment, each end of the tube is closed by a plug (not shown) or other means to prevent communication of the two passageways prior to assembly into the cylinder head. The tube 10 of the invention is inserted at the location shown at 38 in FIG. 2. In locating the tube shown at 38, it is necessary that the tube be permanently affixed so as to maintain the proper orientation of the tube bulkhead 17, i.e. that the tube bulkhead 17 be perpendicular to the lash adjuster bore 14. During assembly of the tube into the cylinder head a temperature differential is created. For example, the tube 10 may be cooled to reduce the outer diameter such as by cryogenic means or alternatively, the cylinder head is heated to increase the diameter of the hole as shown at 38 in FIG. 2 into which the tube is to be inserted. The tube is then oriented and rapidly inserted into the cylinder head. After the temperature is allowed to equalize, a permanent interference fit results between the tube and the mating bore into which it was inserted. In the assembly process, both the cooling of the tube and heating of the cylinder head may be applied.

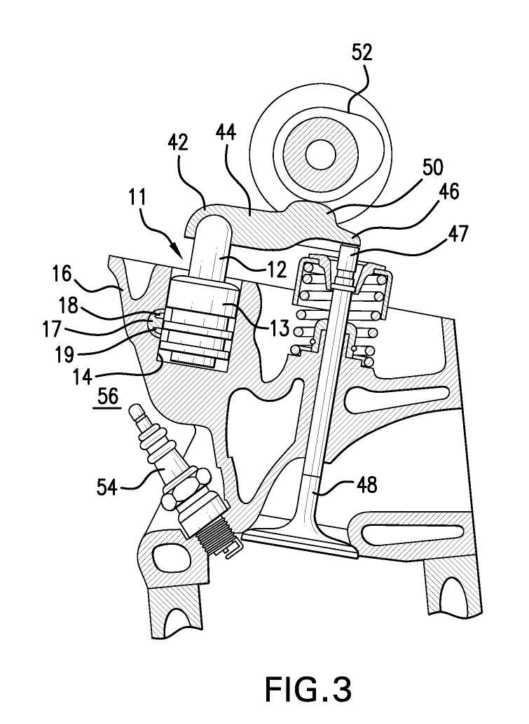

Referring to FIG. 3, when lash adjuster bores are machined into the cylinder head, the passages 18 and 19 of the tube 10 are machined through producing the two separate oil passages 18 and 19 which communicate with lash adjusters 11 installed in the cylinder head 20. The bulkhead 17 separating the two passageways 18 and 19 is sufficiently wide such that it provides a sealing land to minimize leakage/cross-talk between the two separate oil passages. In a cylinder deactivated V8 engine of the kind shown in the above referenced U.S. Pat. No. 6,325,034, for example, the hydraulic lash adjuster oil gallery is typically blind drilled to a depth midway between the middle two cylinders of each cylinder head to permit separate control of valve deactivating devices at either of the two cylinders of the front and rear pairs of cylinders. Subsequent drillings in the cylinder head communicate oil from the oil pump to the oil galleries and to solenoid valves (not shown) controlling valve deactivation devices.

While the invention described details an extended tube insert unit with two lubricating passageways separated from each other, it will be understood that the insert may be formed so as to have more than two separate passageways.

Various modifications will become apparent to one skilled in the art from the above disclosure without departing from the essential concepts of the invention.

What is claimed is:

1. An engine cylinder head containing a discrete longitudinal tubular member wherein said member includes a plurality of integrally preformed distinct longitudinal lubricating oil passageways separated by longitudinal bulk heads, said member being oriented and assembled in a mating tubular opening in said cylinder head by creating a temperature differential between the tubular member and the cylinder head while inserting the tubular member in said opening.

2. The cylinder head of claim 1 wherein the passageways are essentially coextensive.

3. The cylinder head of claim 1 wherein the passageways have a cross-sectional area equivalent to a circle of at least 1.0 mm in diameter.

4. A method of providing an engine cylinder head with dual longitudinal lubricating oil passageways comprising preforming a discrete longitudinal tubular member that includes a plurality of separate coextensive oil passageways and inserting said tubular member in a mating opening in said cylinder head including the steps of treating at least one of either said tubular member or said cylinder head to create a temporary temperature differential between said tubular member and said cylinder head and press fitting said tubular member in said cylinder head.

5. The method of claim 4 wherein the tubular member is cooled.

6. The method of claim 3 wherein the tubular member is cooled cryogenically.

7. The method of claim 5 wherein the cylinder head is heated.

8. The method of claim 6 wherein the cylinder head is heated.
